(19) United States
(12) Patent Application Publication
(10) Pub. No.: US 2025/0296400 A1
(43) Pub. Date: Sep. 25, 2025

(54) AIR CONDITIONING CONTROL APPARATUS FOR VEHICLE

(71) Applicant: SUBARU CORPORATION, Tokyo (JP)

(72) Inventors: Harunobu HORIGUCHI, Tokyo (JP); Junichi SATO, Tokyo (JP); Shigeki OGAWA, Tokyo (JP); Yuusuke SAKATA, Tokyo (JP); Takahito ISOBE, Tokyo (JP)

(21) Appl. No.: 18/976,763

(22) Filed: Dec. 11, 2024

(30) Foreign Application Priority Data
Mar. 21, 2024 (JP) 2024-045150

(51) Int. Cl. B60H 1/00; F24F 11/62; F24F 110/10; F24F 130/00

(52) U.S. Cl. CPC B60H 1/00742; F24F 11/62; F24F 2110/10; F24F 2130/00

(57) ABSTRACT

An air conditioning control apparatus includes a storage and a processor. The storage stores a recommended temperature setting previously set in accordance with an outside air temperature outside a vehicle. The processor stores an off-time outside air temperature and an off-time temperature setting in the storage at a time of turning off a vehicle's ignition switch. The processor controls a vehicle air conditioner based on the off-time temperature setting, upon turning on the ignition switch and when a difference between an outside air temperature at present and the off-time outside air temperature is less than a predetermined value, and controls the vehicle air conditioner based on the recommended temperature setting corresponding to the outside air temperature at present, upon turning on the ignition switch and when the difference between the outside air temperature at present and the off-time outside air temperature is greater than or equal to the predetermined value.

### CROSS-REFERENCE TO RELATED APPLICATIONS

The present application claims priority from Japanese Patent Application No. 2024-045150 filed on Mar. 21, 2024, the entire contents of which are hereby incorporated by reference.

### BACKGROUND

The disclosure relates to an air conditioning control apparatus for a vehicle that is to be mounted on a vehicle and performs air conditioning of an inside of the vehicle.

In typical vehicle air conditioners, a vehicle interior temperature is adjusted based on a temperature (a temperature setting) that is set automatically or by an occupant. In adjusting the vehicle interior temperature, for example, a temperature and a volume of air to be supplied to an inside of a vehicle are adjusted while referring to data indicating environments inside and outside the vehicle including, for example, an outside air temperature and the vehicle interior temperature. In other words, air conditioning control is performed.

For example, Japanese Unexamined Patent Application Publication No. 2017-030376 discloses a vehicle air conditioning control apparatus. The vehicle air conditioning control apparatus selects an outside air temperature to be referred to in air conditioning control in accordance with an elapsed time from when an engine is stopped, or when an ignition switch is turned off, last time. For example, at a time of starting the engine, or turning on the ignition switch, the vehicle air conditioning control apparatus performs the air conditioning control based on an outside air temperature that is stored at stopping of the engine last time when the elapsed time from the stopping of the engine last time is less than a predetermined value, or using an outside air temperature measured at that point in time when the elapsed time is greater than or equal to the predetermined value.

### SUMMARY

An aspect of the disclosure provides an air conditioning control apparatus for a vehicle. The air conditioning control apparatus includes a storage and a processor. The storage is configured to store a recommended temperature setting previously set in accordance with an outside air temperature outside the vehicle. The processor is configured to control a vehicle air conditioner mounted on the vehicle to cause air to be supplied to an inside of the vehicle. The air has a temperature that has been adjusted based on a temperature setting. The processor is configured to store an off-time outside air temperature and an off-time temperature setting in the storage at a time of turning off an ignition switch of the vehicle. The processor is configured to control the vehicle air conditioner based on the off-time temperature setting, at a time of turning on the ignition switch and when a difference between an outside air temperature at present and the off-time outside air temperature is less than a predetermined value. The processor is configured to control the vehicle air conditioner based on the recommended temperature setting corresponding to the outside air temperature at present, at the time of turning on the ignition switch and when the difference between the outside air temperature at present and the off-time outside air temperature is greater than or equal to the predetermined value.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a schematic configuration of a vehicle control system including an air conditioning control apparatus for a vehicle according to one example embodiment of the disclosure.

FIG. 2 is an example of a graph illustrating an ideal vehicle interior temperature Tref corresponding to an outside air temperature Tam on an occupant-by-occupant basis.

FIG. 3 is an example of a table illustrating a relationship between a recommended temperature setting Tset_ref and both of the outside air temperature Tam and the ideal vehicle interior temperature Tref.

FIG. 4 is a graph illustrating an example of a relationship between a vehicle interior temperature Tr at present, the ideal vehicle interior temperature Tref, a deviation ΔTr, the recommended temperature setting Tset_ref, and a correction value Ct.

FIG. 5 is a graph illustrating an example of a relationship between a body surface temperature S of an occupant at present and an ideal body surface temperature Sref.

FIG. 6 is a flowchart illustrating a process flow performed by the air conditioning control apparatus for the vehicle according to one example embodiment of the disclosure to determine whether to use, in determining the temperature setting, a temperature setting Tset_OFF at an end of a previous operation or the recommended temperature setting Tset_ref.

FIG. 7 is a flowchart illustrating a process of step S114 in FIG. 6.

### DETAILED DESCRIPTION

In some vehicle air conditioners, for example, when an ignition switch of a vehicle is turned on, an operation, or an air conditioning control, is started based on a temperature setting stored at a time of turning off the ignition switch last time.

However, for example, when a long period of time has elapsed from a previous turning off of the ignition switch, and environments inside and outside the vehicle have changed at a time of turning on the ignition switch of the vehicle, the air conditioning control based on a temperature setting at the previous turning off of the ignition switch is inappropriate and may possibly impair comfort of an occupant. In addition, because a sensory temperature and an ideal vehicle interior temperature differ depending on occupants, the air conditioning control based on the temperature setting at the previous turning off of the ignition switch is not necessarily appropriate for an occupant. What is desired is to optimize a temperature setting and perform appropriate air conditioning control in accordance with environments inside and outside a vehicle.

It is desirable to provide an air conditioning control apparatus for a vehicle that makes it possible to optimize a temperature setting, perform appropriate air conditioning control in accordance with environments inside and outside a vehicle, and improve comfort of an occupant accordingly.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

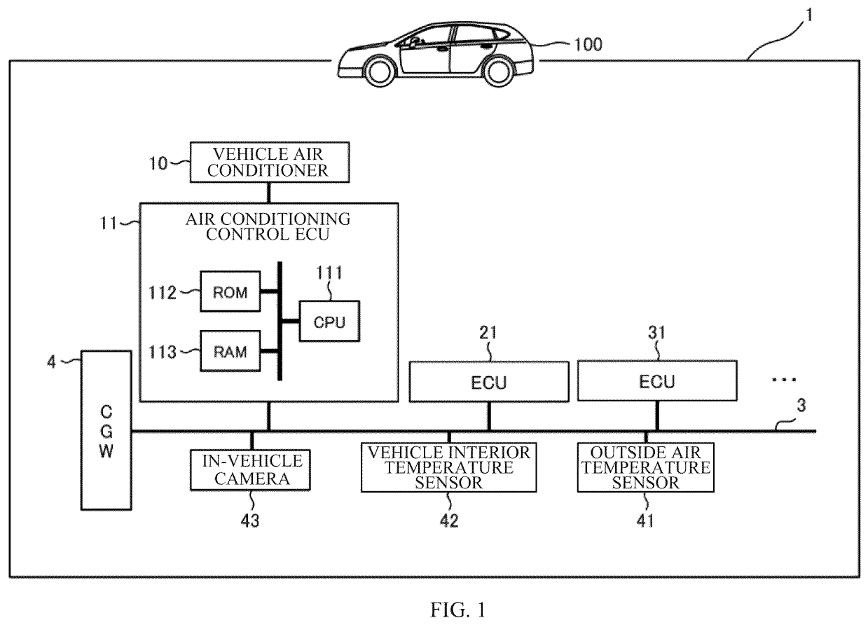

As illustrated in FIG. 1, an air conditioning control apparatus for a vehicle (hereinafter simply referred to as a “vehicle air conditioning control apparatus”) according to an example embodiment may serve as part of a vehicle control system 1. The vehicle control system 1 may be mounted on a vehicle 100. The vehicle air conditioning control apparatus may include an air conditioning control ECU 11. The vehicle control system 1 may include sensors, various devices, and electronic control units (ECUs) that control the sensors and the devices. The sensors may acquire various kinds of data indicating a traveling state of the vehicle 100 and environments inside and outside the vehicle 100. The devices may be used for the traveling of the vehicle 100. In one embodiment, the air conditioning control ECU 11 may serve as the “vehicle air conditioning control apparatus”.

Out of multiple ECUs, FIG. 1 illustrates the air conditioning control ECU 11, an ECU 21, and an ECU 31. The air conditioning control ECU 11 may serve as the vehicle air conditioning control apparatus. Illustration of other ECUs is omitted. In addition, out of various sensors and devices, FIG. 1 illustrates an outside air temperature sensor 41, a vehicle interior temperature sensor 42, and an in-vehicle camera 43. The outside air temperature sensor 41 may detect a temperature of air outside the vehicle 100. The vehicle interior temperature sensor 42 may detect a temperature inside the vehicle 100. The in-vehicle camera 43 may capture an image of an inside of the vehicle 100. Illustration of other sensors and devices is omitted.

In the example embodiment, detailed description and illustration of ECUs, sensors, and electronic devices that do not participate in an operation performed as the vehicle air conditioning control apparatus are omitted even if these components are included in the vehicle control system 1.

The sensors, the devices, and the ECUs may be communicably coupled to each other by an in-vehicle network 3, such as a controller area network (CAN) or a local interconnect network (LIN), and a central gateway (CGW) 4. The central gateway (CGW) 4 may serve as a relay device.

In the vehicle control system 1, data acquired by each of the sensors may be outputted to the in- vehicle network 3, and data indicating an operation state of a device to be controlled may be outputted from each of the ECUs to the in-vehicle network 3. Hereinafter, the device to be controlled may be referred to as a control target device. Further, each of the ECUs may control operation of the corresponding control target device, based on data from the sensors and other ECUs acquired through the in-vehicle network 3.

Each of the ECUs may include, for example, a processor such as a central processing unit (CPU) or a micro processing unit (MPU), and an electric circuit. Hereinafter, the processor and the electric circuit may be referred to as a “processor and other components”. Each of the ECUs may execute various processes by the processor and other components. Each of the ECUs may include a volatile storage element such as a random access memory (RAM) and a nonvolatile storage element such as a read only memory (ROM). The RAM may temporarily process data to be used by the processor and other components. The ROM may store, for example, programs to be executed by the processor and other components. In some embodiments, all or a part of operation to be executed by one or more of the ECUs may be implemented by hardware such as an application specific integrated circuit (ASIC), a field-programmable gate array (FPGA), or a graphics processing unit (GPU).

As illustrated in FIG. 1, the air conditioning control ECU 11 may be coupled to a vehicle air conditioner 10 and perform air conditioning control based on a temperature setting in the vehicle air conditioner 10. For example, the air conditioning control ECU 11 may control the vehicle air conditioner 10 to maintain a temperature inside the vehicle 100 to be equal to the temperature setting. In controlling the vehicle air conditioner 10, the air conditioning control ECU 11 may perform, for example, adjustment of a temperature of air taken into the vehicle air conditioner 10 and adjustment of a supply rate, or a blowing amount, of temperature-adjusted air to the inside of the vehicle 100.

The air conditioning control ECU 11 may acquire, for example, an outside air temperature Tam detected by the outside air temperature sensor 41, a vehicle interior temperature Tr detected by the vehicle interior temperature sensor 42, imaging data of the inside of the vehicle 100 captured by the in-vehicle camera 43 via the in-vehicle network 3. The air conditioning control ECU 11 may perform the air conditioning control while referring to these pieces of data.

The air conditioning control ECU 11 may include a CPU 111, a ROM 112, and a RAM 113. The CPU 111 may execute various processes based on programs stored in the ROM 112.

The ROM 112 provided as the nonvolatile storage element may store programs that control the vehicle air conditioner 10 and various pieces of data to be used to execute the programs. In one embodiment, the ROM 112 may serve as a “storage”. In one embodiment, the CPU 111 may serve as a “processor”.

As the various pieces of data, the ROM 112 may store data to be referred to in automatically setting a temperature setting Tset to be used for the air conditioning control. The data may include, for example, an ideal vehicle interior temperature Tref corresponding to the outside air temperature Tam on an occupant-by-occupant basis and a recommended temperature setting Tset_ref previously set in accordance with the outside air temperature Tam.

### Data Stored in ROM 112

Hereinafter, the data previously stored in the ROM 112 will be described. The data previously stored in the ROM 112 may include data to be used by the air conditioning control ECU 11 in automatically determining the temperature setting Tset of the vehicle air conditioner 10. In the example embodiment, the ROM 112 may store, as examples of such data, at least (1) data of the ideal vehicle interior temperature Tref corresponding to the outside air temperature Tam on the occupant-by-occupant basis, and (2) data indicating the recommended temperature setting Tset_ref corresponding to the outside air temperature Tam and the ideal vehicle interior temperature Tref.

### (1) Data of Ideal Vehicle Interior Temperature Tref Corresponding to Outside Air Temperature Tam on Occupant-by-Occupant Basis

In the air conditioning control ECU 11, the ROM 112 may previously store data indicating the ideal vehicle interior temperature Tref corresponding to the outside air temperature Tam on the occupant-by-occupant basis for occupants who may get on the vehicle 100. The ideal vehicle interior temperature Tref may indicate an ideal temperature inside the vehicle 100. The ideal temperature may be a temperature that is assumed to make it possible to maintain comfort of each occupant. Even if the outside air temperature Tam is the same, thermal sensation and the sensory temperature may differ depending on occupants, and accordingly, the ideal vehicle interior temperature Tref may also differ depending on occupants. It is therefore possible to determine the temperature setting Tset optimal for each occupant by utilizing occupant-by-occupant data in which the outside air temperature Tam and the ideal vehicle interior temperature Tref are associated with each other.

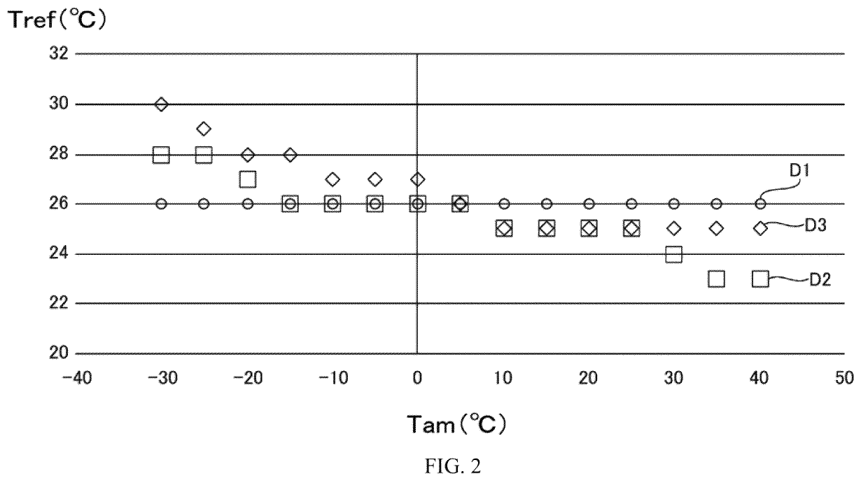

FIG. 2 is an example of a graph illustrating the ideal vehicle interior temperature Tref corresponding to the outside air temperature Tam on the occupant-by-occupant basis. The example in FIG. 2 illustrates the relationship between the outside air temperature Tam and the ideal vehicle interior temperature Tref of each of three occupants D1, D2, and D3. In FIG. 2, ideal vehicle interior temperature data of the occupant D1 is indicated by open circles, ideal vehicle interior temperature data of the occupant D2 is indicated by open squares, and ideal vehicle interior temperature data of the occupant D3 is indicated by open diamonds.

In FIG. 2, for example, when the outside air temperature Tam is −30° C., the ideal vehicle interior temperature Tref of the occupant D1 may be 26° C., the ideal vehicle interior temperature Tref of the occupant D2 may be 28° C., and the ideal vehicle interior temperature Tref of the occupant D3 may be 30° C. As described above, by referring to the graph of FIG. 2, it is possible to grasp the ideal vehicle interior temperature Tref corresponding to the outside air temperature Tam on the occupant-by-occupant basis.

It is possible to acquire the data indicating the ideal vehicle interior temperature Tref corresponding to the outside air temperature Tam on the occupant-by-occupant basis by, for example, performing a computation based on one or more of factors including, for example but not limited to, the temperature setting Tset that is set when each of the occupants D1, D2, and D3 used the vehicle air conditioner 10 in the vehicle 100 and a temperature adjusting operation performed manually by each of the occupants D1, D2, and D3.

### (2) Data Indicating Recommended Temperature Setting Tset_ref Corresponding to Outside Air Temperature Tam and Ideal Vehicle Interior Temperature Tref

It is possible for the air conditioning control ECU 11 to perform the air conditioning control of the vehicle air conditioner 10 with the ideal vehicle interior temperature Tref of an occupant being set as the temperature setting Tset without being changed. However, by increasing the temperature setting Tset as the outside air temperature Tam is decreased, and decreasing the temperature setting Tset as the outside air temperature Tam is increased, it is possible to allow the temperature inside the vehicle 100 to reach the ideal vehicle interior temperature Tref at an earlier stage, and to improve the comfort of the occupant. Given the circumstances, in the air conditioning control ECU 11, the data indicating the recommended temperature setting Tset_ref corresponding to the outside air temperature Tam and the ideal vehicle interior temperature Tref may be previously stored in the ROM 112.

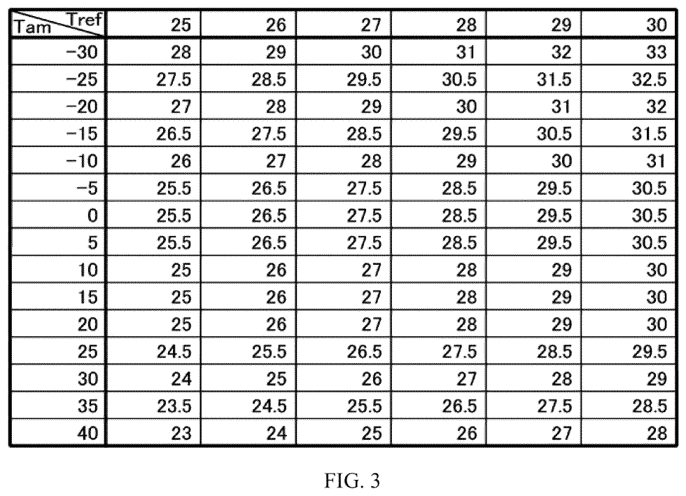

FIG. 3 is an example of a table illustrating a relationship between the recommended temperature setting Tset_ref and both of the outside air temperature Tam and the ideal vehicle interior temperature Tref. The example in FIG. 3 demonstrates that, in some embodiments, at a time when the outside air temperature Tam is 5° C., the recommended temperature setting Tset_ref may be 25.5° C. when the ideal vehicle interior temperature Tref is 25° C., and the recommended temperature setting Tset_ref may be 28.5° C. when the ideal vehicle interior temperature Tref is 28° C.

In some embodiments, the recommended temperature setting Tset_ref corresponding to the outside air temperature Tam and the ideal vehicle interior temperature Tref as described above may be determined in accordance with, for example, specifications and performance of the vehicle air conditioner 10, a volume of the inside of the vehicle 100, and an area of windows provided in the vehicle 100, and may be computed and stored in the ROM 112 in advance.

The RAM 113 provided as a volatile storage element may be used as a work area when the CPU 111 executes various kinds of processes. For example, the outside air temperature Tam, the vehicle interior temperature Tr, and the imaging data of the inside of the vehicle 100 that are acquired through the in-vehicle network 3 may be temporarily stored in the RAM 113 as necessary.

The CPU 111 may control the vehicle air conditioner 10 by reading a program stored in the ROM 112 into the memory such as the RAM 113 and executing the program.

For example, the CPU 111 controls the vehicle air conditioner 10 as follows.

At an end of the operation of the vehicle air conditioner 10, including a case in which the operation of the vehicle air conditioner 10 is ended at the same time as when the ignition switch of the vehicle 100 is turned off, the CPU 111 causes an outside air temperature Tam_OFF and a set value for the vehicle air conditioner 10 at the end of the operation to be temporarily stored in the ROM 112 or the RAM 113.

The set value for the vehicle air conditioner 10 at the end of the operation may include, for example, a temperature setting Tset_OFF, a temperature of air blown into a vehicle compartment (a target blowing temperature TAO), and a blowing amount. Which of these values is to be stored as the set value may be determined as appropriate. Here, the CPU 111 may store at least the temperature setting Tset_OFF as the set value for the vehicle air conditioner 10. In one embodiment, the outside air temperature Tam_OFF may serve as an “off-time outside air temperature”. In one embodiment, the temperature setting Tset_OFF may serve as an “off-time temperature setting”.

When an instruction to start operation of the vehicle air conditioner 10 is received, including a case in which the instruction to start the operation of the vehicle air conditioner 10 is received at the same time as when the ignition switch of the vehicle 100 is turned on, the CPU 111 may determine the temperature setting Tset to be used at a start of the operation.

For example, when the instruction to start the operation is inputted to the vehicle air conditioner 10, the CPU 111 may acquire at least temperature data out of environment data indicating the environments inside and outside the vehicle 100, and determine, based on the temperature data, the temperature setting Tset to be used at the start of the operation. For example, the CPU 111 may acquire the outside air temperature Tam_OFF stored at an end of a previous operation of the vehicle air conditioner 10 as the temperature data out of the above-described environment data. The CPU 111 may also acquire, via the in-vehicle network 3, the outside air temperature Tam at present detected by the outside air temperature sensor 41.

When the outside air temperature Tam_OFF and the outside air temperature Tam are regarded as the same, or, for example, when a difference ΔTam between the outside air temperature Tam_OFF and the outside air temperature Tam is less than a predetermined value Tdif, the vehicle air conditioner 10 is controlled based on the temperature setting Tset_OFF stored at the end of the previous operation. In contrast, when the outside air temperature Tam_OFF at the end of the previous operation and the outside air temperature Tam are not regarded as the same, or, for example, when the difference ΔTam between the outside air temperature Tam_OFF and the outside air temperature Tam is greater than or equal to the predetermined value Tdif, the vehicle air conditioner 10 is controlled based on the recommended temperature setting Tset_ref corresponding to the outside air temperature Tam at present.

In some embodiments, in determining whether to use, as the temperature setting Tset at the start of the operation, the temperature setting Tset_OFF that has been stored, the vehicle interior temperature Tr and an occupant condition may be referred to in addition to the outside air temperature Tam at present and the outside air temperature Tam_OFF that has been stored, as the temperature data.

In some embodiments, the CPU 111 may acquire at least occupant data indicating the occupant condition and vehicle interior temperature data out of the environment data indicating the environments inside and outside the vehicle 100. When the recommended temperature setting Tset_ref is to be corrected, the CPU 111 may correct the recommended temperature setting Tset_ref, based on the environment data.

In some embodiments, the environment data may include, for example, the imaging data of the inside of the vehicle 100 captured by the in-vehicle camera 43 and the vehicle interior temperature Tr detected by the vehicle interior temperature sensor 42. The CPU 111 may calculate a corrected recommended temperature setting Tset_co. To calculate the corrected recommended temperature setting Tset_co, the recommended temperature setting Tset_ref may be corrected based on a body surface temperature of the occupant acquired from the imaging data and the vehicle interior temperature Tr. The CPU 111 may control the vehicle air conditioner 10, based on the corrected recommended temperature setting Tset_co. In one embodiment, the corrected recommended temperature setting Tset_co may serve as a “corrected temperature setting”.

Whether the recommended temperature setting Tset_ref is to be corrected may be determined based on, for example, a degree of a deviation ΔTr between the vehicle interior temperature Tr at present and the recommended temperature setting Tset_ref, or between the vehicle interior temperature Tr at present and the ideal vehicle interior temperature Tref. The greater the deviation ΔTr, the longer the time for the vehicle interior temperature to reach the recommended temperature setting Tset_ref, which may possibility impair the comfort of the occupant. Accordingly, the CPU 111 improves the comfort by correcting the recommended temperature setting Tset_ref based on the deviation ΔTr.

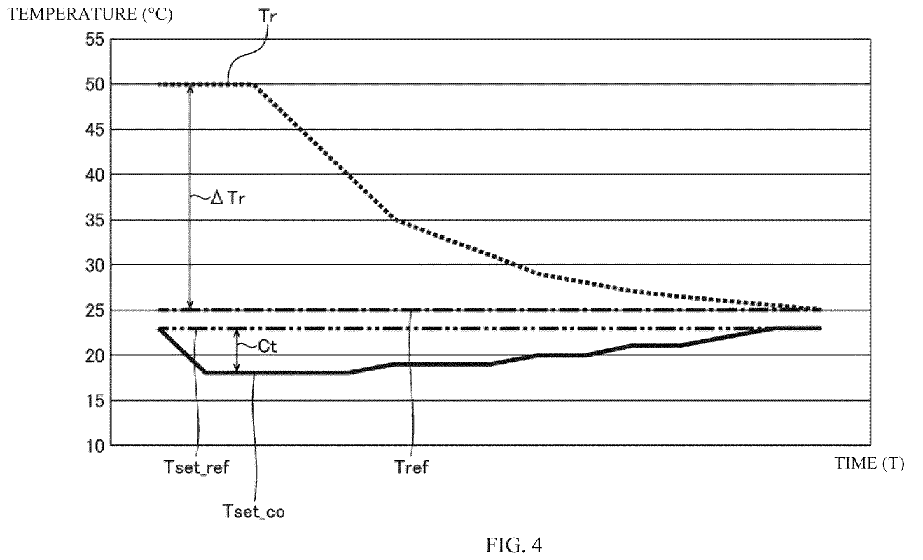

FIG. 4 is a graph illustrating an example of a relationship between the vehicle interior temperature Tr at present, the ideal vehicle interior temperature Tref, the deviation ΔTr, the recommended temperature setting Tset_ref, and a correction value Ct. As illustrated in FIG. 4, the larger the deviation ΔTr, the larger the correction value Ct. When the deviation ΔTr is greater than or equal to a predetermined value, the CPU 111 may calculate the corrected recommended temperature setting Tset_co by correcting the recommended temperature setting Tset_ref in accordance with the correction value Ct obtainable based on the deviation ΔTr. When the deviation ΔTr is less than the predetermined value, it is determined that the recommended temperature setting Tset_ref is not to be corrected based on the deviation ΔTr.

In addition to the deviation ΔTr, whether the recommended temperature setting Tset_ref is to be corrected may also be determined based on, for example, a body surface temperature S of the occupant. For example, it is determined whether the recommended temperature setting Tset_ref is to be corrected, based on a degree of a deviation ΔS between the body surface temperature S of the occupant at present and an ideal body surface temperature Sref.

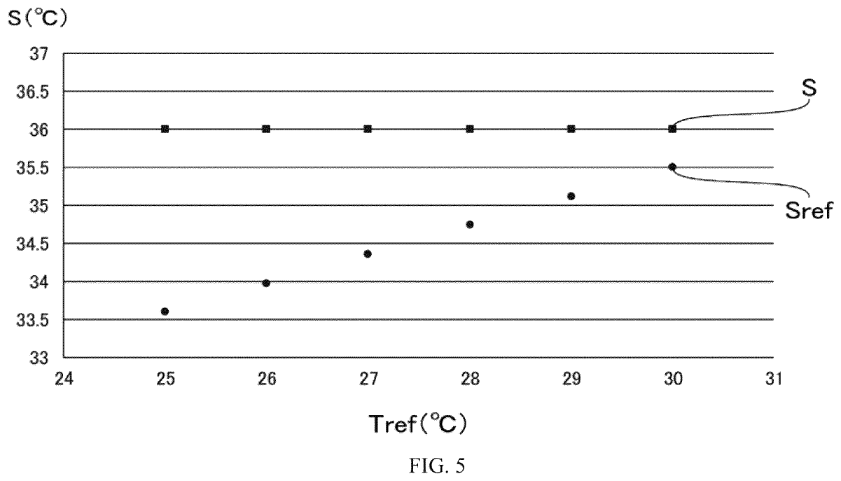

FIG. 5 illustrates an example of a relationship between the body surface temperature S of the occupant at present and the ideal body surface temperature Sref. When the deviation ΔS is greater than or equal to a predetermined value, the CPU 111 may calculate the corrected recommended temperature setting Tset_co by correcting the recommended temperature setting Tset_ref in accordance with a correction value Cs obtainable based on the deviation ΔS. When the deviation AS is less than the predetermined value, it is determined that the recommended temperature setting Tset_ref is not to be corrected based on the deviation ΔS.

Further, it is also possible to determine whether the recommended temperature setting Tset_ref is to be corrected using both of the deviation ΔTr and the deviation ΔS. In this case, the correction of the recommended temperature setting Tset_ref is performed using the correction value Ct and the correction value Cs. When the correction value Ct and the correction value Cs cancel each other out, it is determined that the recommended temperature setting Tset_ref is not to be corrected.

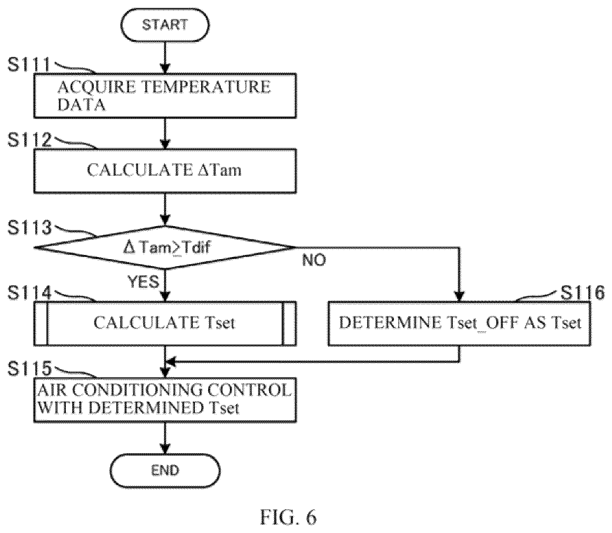

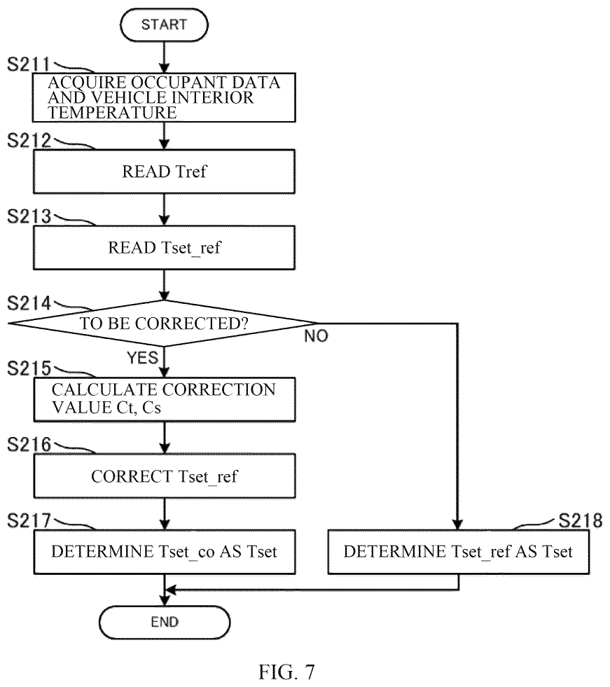

The process performed by the air conditioning control ECU 11 configured as described above will be described with reference to the flowcharts of FIGS. 6 and 7. FIG. 6 illustrates a process flow to determine whether to use, in determining the temperature setting, the temperature setting Tset_OFF at the end of the previous operation or the recommended temperature setting Tset_ref. FIG. 7 illustrates a process flow performed in step S114 of the flowchart of FIG. 6 and illustrates a process of calculating the temperature setting Tset, based on the recommended temperature setting Tset_ref.

As illustrated in FIG. 6, when the ignition switch of the vehicle 100 is turned on, and the instruction to start the operation of the vehicle air conditioner 10 is received, the air conditioning control ECU 11 may be activated and acquire the temperature data (step S111). Here, the air conditioning control ECU 11 may acquire the outside air temperature Tam at present as the temperature data via the in-vehicle network 3, and read the outside air temperature Tam_OFF stored at the end of the previous operation.

The air conditioning control ECU 11 may calculate the difference ΔTam between the outside air temperature Tam_OFF and the outside air temperature Tam (step S112), and determine whether the difference ΔTam is greater than or equal to the predetermined value Tdif (step S113). In the determination, when the difference ΔTam between the outside air temperature Tam_OFF and the outside air temperature Tam is greater than or equal to the predetermined value Tdif (YES in step S113), the air conditioning control ECU 11 may perform a process of calculating the temperature setting Tset, based on the recommended temperature setting Tset_ref corresponding to the outside air temperature Tam at present (step S114). Note that the air conditioning control ECU 11 may discard, or mark as unused data or delete from a storage, the temperature setting Tset_OFF stored at the end of the previous operation when causing the process to proceed to step S114.

In contrast, when the difference ΔTam is less than the predetermined value Tdif (NO in step S113), the temperature setting Tset_OFF stored at the end of the previous operation may be determined as the temperature setting Tset (step S116). When the temperature setting Tset is determined in step S114 or step S116, the air conditioning control for the vehicle air conditioner 10 may be started with the temperature setting Tset that has been determined (step S115).

Next, referring to the flowchart of FIG. 7, the process performed in step S114 of the flowchart of FIG. 6 will be described. The process may include calculating the temperature setting Tset based on the recommended temperature setting Tset_ref corresponding to the outside air temperature Tam at present.

As illustrated in FIG. 7, the air conditioning control ECU 11 may acquire the occupant data indicating the occupant condition and the vehicle interior temperature data out of the environment data indicating the environments inside and outside the vehicle 100 (step S211). When the occupant on the vehicle 100 is identified by the occupant data acquired in step S211, the air conditioning control ECU 11 may read the ideal vehicle interior temperature Tref of the occupant corresponding to the outside air temperature Tam at present acquired in step S111 of FIG. 6 (step S212). Thereafter, the air conditioning control ECU 11 may read the recommended temperature setting Tset_ref determined by the ideal vehicle interior temperature Tref and the outside air temperature Tam at present (step S213).

Thereafter, the air conditioning control ECU 11 may determine whether the recommended temperature setting Tset_ref that has been read is to be corrected (step S214). Note that, whether the recommended temperature setting Tset_ref that has been read is to be corrected, may be determined based on, for example, one or both of the degree of the deviation ΔTr between the vehicle interior temperature Tr at present and the recommended temperature setting Tset_ref, or between the vehicle interior temperature Tr at present and the ideal vehicle interior temperature Tref, and the degree of the deviation ΔS between the body surface temperature S of the occupant at present and the ideal body surface temperature Sref, as described above.

When it is determined that the recommended temperature setting Tset_ref that has been read is not to be corrected (NO in step S214), the recommended temperature setting Tset_ref may be determined as the temperature setting Tset without being changed (step S218). When it is determined that the recommended temperature setting Tset_ref is to be corrected (YES in step S214), one or both of the correction value Ct and the correction value Cs may be calculated (step S215), and the recommended temperature setting Tset_ref may be corrected using one or both of the calculated correction value Ct and the calculated correction value Cs (step S216). When the corrected recommended temperature setting Tset_co is obtained by correcting the recommended temperature setting Tset_ref, the corrected recommended temperature setting Tset_co may be determined as the temperature setting Tset (step S217).

According to the air conditioning control ECU 11, or the vehicle air conditioning control apparatus, of the above-described example embodiment, when the environments inside and outside the vehicle 100 have not changed from the end of the previous operation of the vehicle air conditioner 10, the temperature setting Tset_OFF stored at the end of the previous operation is used. In contrast, when the environments inside and outside the vehicle 100 have changed, the temperature setting Tset is determined in accordance with the change. With this configuration, it is possible to optimize the temperature setting and perform appropriate air conditioning control in accordance with the environments inside and outside the vehicle 100. This helps to improve the comfort of the occupant.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

According to an air conditioning control apparatus for a vehicle of at least one example embodiment of the disclosure, it is possible to optimize a temperature setting and to appropriately perform air conditioning control in accordance with environments inside and outside a vehicle. This makes it possible to improve comfort of an occupant.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The CPU 111 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the CPU 111. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the CPU 111 illustrated in FIG. 1.

1. An air conditioning control apparatus for a vehicle, the air conditioning control apparatus comprising:
a storage configured to store a recommended temperature setting previously set in accordance with an outside air temperature outside the vehicle; and
a processor configured to control a vehicle air conditioner mounted on the vehicle to cause air to be supplied to an inside of the vehicle, the air having a temperature that has been adjusted based on a temperature setting, wherein
the processor is configured to
store an off-time outside air temperature and an off-time temperature setting in the storage at a time of turning off an ignition switch of the vehicle,
control the vehicle air conditioner based on the off-time temperature setting, at a time of turning on the ignition switch and when a difference between an outside air temperature at present and the off-time outside air temperature is less than a predetermined value, and
control the vehicle air conditioner based on the recommended temperature setting corresponding to the outside air temperature at present, at the time of turning on the ignition switch and when the difference between the outside air temperature at present and the off-time outside air temperature is greater than or equal to the predetermined value.

2. The air conditioning control apparatus for the vehicle according to claim 1, wherein
the processor is configured to
acquire environment data based on an environment outside the vehicle and an environment inside the vehicle, and
control the vehicle air conditioner based on a corrected temperature setting, at the time of turning on the ignition switch and when the difference between the outside air temperature at present and the off-time outside air temperature is greater than or equal to the predetermined value, the corrected temperature setting comprising the recommended temperature setting corresponding to the outside air temperature at present being corrected in accordance with the environment data.

3. The air conditioning control apparatus for the vehicle according to claim 2, wherein
the environment data comprises a body surface temperature of an occupant on the vehicle, and
the processor is configured to acquire the body surface temperature, based on an imaging data captured by a camera, the camera being configured to capture an image of the inside of the vehicle.

4. The air conditioning control apparatus for the vehicle according to claim 1, wherein the recommended temperature setting is set in accordance with: an ideal vehicle interior temperature set on an occupant-by-occupant basis; and the outside air temperature.

5. The air conditioning control apparatus for the vehicle according to claim 4, wherein the ideal vehicle interior temperature is determined in accordance with the outside air temperature on the occupant-by-occupant basis and is determined based on one or both of: a temperature setting set by an occupant; and a temperature adjusting operation performed by the occupant.
